(19) United States
(12) Patent Application Publication
(10) Pub. No.: US 2007/0192537 A1
(43) Pub. Date: Aug. 16, 2007

(54) Request processing order in a cache

(76) Inventors: John I. Garney, Portland, OR (US); Robert J. Royer JR., Portland, OR (US); Michael K. Eschmann, Lees Summit, MO (US); Daniel Nemiroff, Folsom, CA (US)

Correspondence Address: TROP PRUNER & HU, PC, 1616 S. VOSS ROAD, SUITE 750, HOUSTON, TX, 77057-2631, US

(21) Appl. No.: 11/788,607

(22) Filed: Apr. 20, 2007

Related U.S. Application Data
(63) Continuation of application No. 10/739,921, filed on Dec. 18, 2003.

(51) Int. Cl. G06F 12/00; G06F 13/00; G06F 12/14

(52) U.S. Cl. 711/112; 711/113; 711/163; 711/167

(57) ABSTRACT

A method and apparatus for preserving the processing order of some requests in a system is disclosed. The method may include blocking requests from executing based on a blocked count data field, blocking list data field, and a last request data field. The apparatus may include a system or a memory device.

### CROSS-REFERENCE TO RELATED APPLICATION

This application is a continuation of U.S. patent application Ser. No. 10/739,921, filed Dec. 18, 2003.

### BACKGROUND

Peripheral devices such as disk drives used in processor-based systems may be slower than other circuitry in those systems. There have been many attempts to increase the performance of disk drives. However, because disk drives are electromechanical, there may be a finite limit beyond which performance cannot be increased. One way to reduce the information bottleneck at the peripheral device, such as a disk drive, is to use a cache. A cache is a memory device that logically resides between a device, such as a disk drive, and the remainder of the processor-based system. Frequently accessed data resides in the cache after an initial access. Subsequent accesses to the same data may be made to the cache instead of to the disk drive.

Disk requests made to a disk subsystem may be completed in an order different than they were requested. Disk subsystems may service disk requests in sequential order, but may also modify the order to increase performance. For example, an elevator algorithm which may minimize disk head movement and thus increase performance may be used.

In a system which includes a disk cache, the servicing order may be further changed since requests which may have required disk service may now be fully serviced by the disk cache. For disk requests that have no logical block addresses in common, there may be no reason that one request will affect another. However, when disk requests involve common logical block addresses, the order in which the disk requests are executed may be important. For example, if a first request causes disk data to be allocated dirty, which may involve a disk read into a cache line and then a cache write into the same cache line; and if a second disk request writes to the same disk logical block address, then the second request may write the data to the cache line after the first request gets read from the disk, but before the first request writes the data to the cache. Thus, the cache would have the wrong data.

Thus, a need exists for preserving the processing order of some disk requests in a system.

### BRIEF DESCRIPTION OF THE DRAWINGS

FIG. 1 is a block diagram of a processor-based system in accordance with an embodiment of the present invention;

FIG. 2 is a flow chart of a method in accordance with an embodiment of the present invention;

FIG. 3 is a flow chart of a method in accordance with another embodiment of the present invention; and

FIG. 4 is a block diagram of a blocking map in accordance with another embodiment of the present invention.

### DETAILED DESCRIPTION

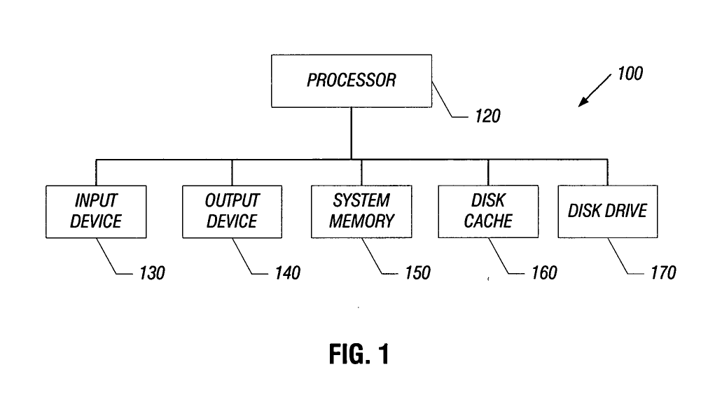

Referring to FIG. 1, a processor-based system 100 may be a computer, a server, a telecommunication device, or any other variety of other processor-based systems. The system 100 may include an input device 130 coupled to a processor 120. The input device 130 may include a keyboard or a mouse. The system 100 may also include an output device 140 coupled to the processor 120. The output device 140 may include a display device such as a cathode ray tube monitor, liquid crystal display, or a printer. Additionally, the processor 120 may be coupled to system memory 150 which may include any number of memory devices such as a plurality of read-only memory (ROM) or random access memory (RAM). Additionally, the system 100 may include a disk cache 160 coupled to the processor 120. The disk cache 160 may include an option read-only memory which may be a medium for storing instructions and/or data. Other mediums for storing instructions may include memory system 150, disk cache 160, or disk drive 170. The processor 120 may also be coupled to disk drive 170 which may be a hard drive, a solid state disk device, a floppy drive, a compact disk drive (CD), or a digital video disk (DVD).

Disk cache 160 may be made from a ferroelectric polymer memory. Data may be stored in layers within the memory. The higher the number of layers, the higher the capacity of the memory. Each of the polymer layers may include polymer chains with dipole moments. Data may be stored by changing the polarization of the polymer between metal lines.

Ferroelectric polymer memories are non-volatile memories with sufficiently fast read and write speeds. For example, microsecond initial reads may be possible with write speeds comparable to those with flash memories.

In another embodiment, disk cache 160 may include dynamic random access memory or flash memory. A battery may be included with the dynamic random access memory to provide non-volatile functionality.

In the typical operation of system 100, the processor 120 may access system memory 150 to retrieve and then execute a power on self-test (POST) program and/or a basic input output system (BIOS) program. The processor 120 may use the BIOS or POST software to initialize the system 100. The processor 120 may then access the disk drive 170 to retrieve and execute operating system software. The operating system software may include device drivers which may include, for example, a cache driver.

The system 100 may also receive input from the input device 130 where it may run an application program stored in system memory 150. The system 100 may also display the system 100 activity on the output device 140. The system memory 150 may be used to hold application programs or data that is used by the processor 120. The disk cache 160 may be used to cache data for the disk drive 170, although the scope of the present invention is not so limited.

The components in system 100 may generate disk requests which may be serviced by either the disk cache 160 or disk drive 170. These disk requests may be serviced in sequential order but may also be serviced out of order to improve performance. For disks requests having common logical block addresses, the sequence of execution may be significant.

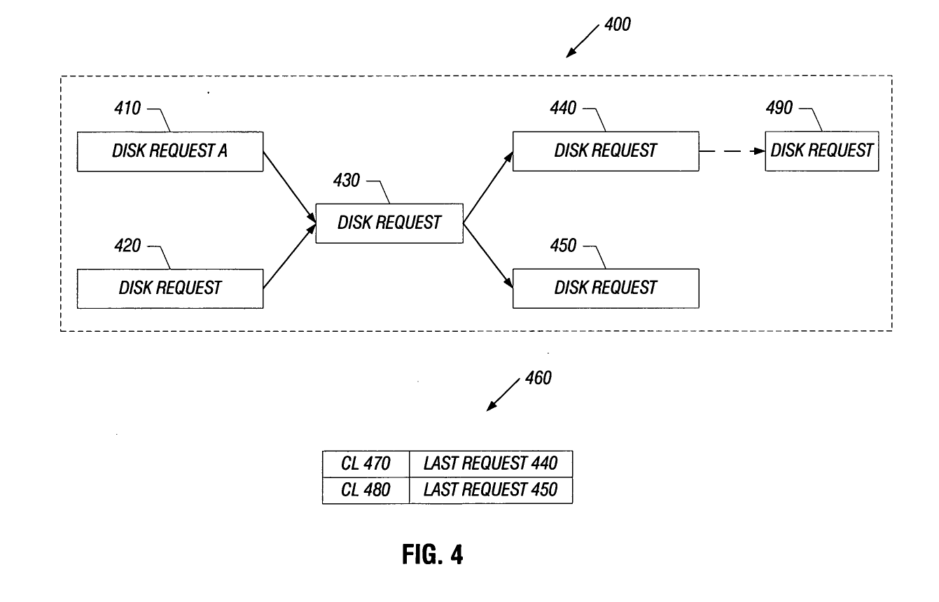

Referring to FIG. 4 a blocking graph 400 of interdependent disk requests or sub-requests may be disclosed in one embodiment of the invention. The rectangles in blocking graph 400 may represent outstanding disk requests or sub-requests in a system. The arrows in between the rectangles represent when one disk requests must be completed before the disk requests being referenced. Disk requests 430 may be blocked by disk request 410 and 420. Similarly, disk requests 440 and 450 may be blocked by disk requests 430, 420, and 410 in this example. Depending on the cache lines affected by a given disk requests, completion of one blocked disk request can unblock several other previously blocked requests. In general, blocked requests may have many to many relationships. One request may block many subsequent requests and many previous requests can block one request, in other examples.

In blocking graph 400, disk request 440 may be the last request that may operate on a cache line (CL) 470 in cache 460 of FIG. 4, in this example. Similarly, disk request 450 may be the last disk request that may operate on cache line (CL) 480. Cache 460 may include additional cache lines which are not shown in this example. Additionally, cache lines 470 and 480 may have additional fields, such as a cache line tag or cache line state, which are not shown in this example.

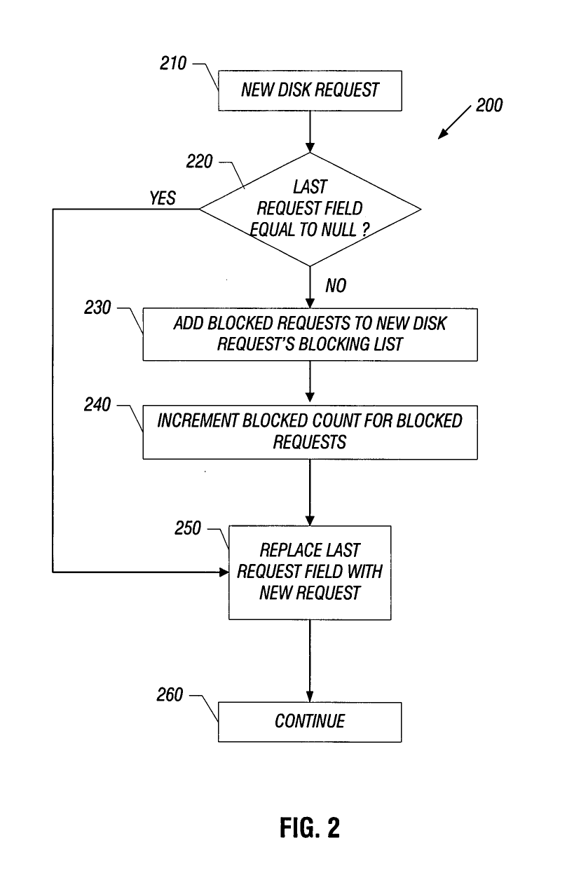

Referring to FIG. 2, an algorithm 200 for building a blocking graph and preserving the processing order for some requests in a processor-based system may be disclosed as one embodiment of the invention. In algorithm 200, cache lines of disk cache 160 may have a last request data field which identifies a last outstanding request for this cache line. The last outstanding request for a cache line is the last request which may use or change the data in a cache line. Additionally, a disk request may have a blocking list associated with the request which may identify all the requests that it is blocking. A first request may block another request when the first request will operate on a cache line that the other request will also operate on and where the sequence of the operations may be important. A disk request may also have a blocked count associated with the disk request which may store the number of disk requests which are blocking it.

A processor-based system 100 may execute code which may include a new disk request, as illustrated in block 210. The new disk request may reference a cache line, which may include a last request data field. The last request data field may identify the last outstanding request for the referenced cache line or may contain null data which may indicate that there are no outstanding disk requests for this cache line.

If the last request data field for the referenced cache line is equal to a null, then the new request is identified in the last request data field of the subject cache line, as indicated in diamond 220 and block 250. If the last request data field is not equal to a null, then the blocked disk requests are added to the new request's blocking list, as indicated in block 230. A request's blocking list identifies the disk requests that it is blocking.

Then the requests which are blocked by the new disk request may increment their respective blocked count, as indicated in block 240. Block 260 then indicates that the process may continue by either executing disk requests that have a blocked count data field equal to zero and are therefore not blocked, or receiving new disk requests.

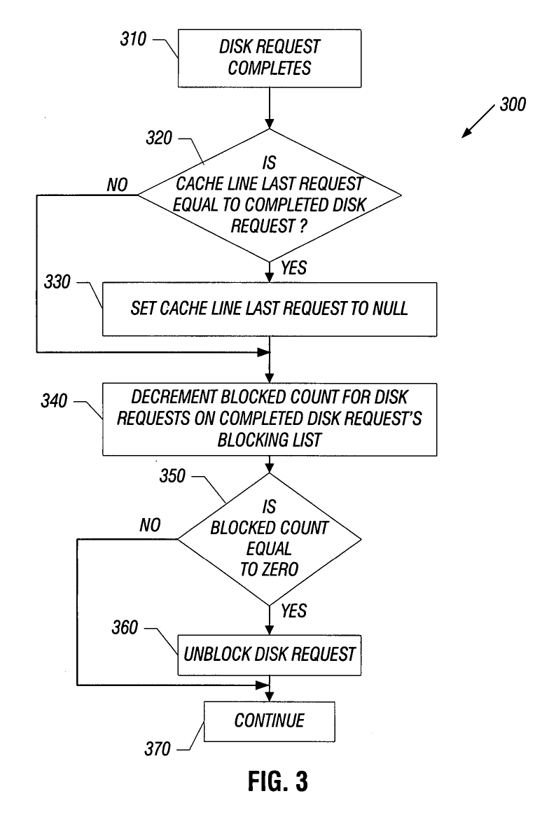

Referring to FIG. 3, the algorithm 300 may use the last request data for cache lines and the blocked list and blocked count data of disk requests to further maintain the blocking graph and further preserve the processing order of some requests. When a disk request completes, as indicated in block 310, the disk request has been executed. Upon completion, the relevant cache line last request is compared to the completed disk request. If the relevant cache line's last request identifies the completed disk request, as indicated in diamond 320, then the last request data for this cache line is set to null, as indicated in diamond 320 and block 330. Then, the blocked count for the disk requests which are on the completed disk requests blocking lists are decremented, as indicated in block 340. For disk requests which now have block counts equal to zero, the disk request would be unblocked as indicated in diamond 360 and block 370. Then, the processes of unblocking requests using algorithm 300 would continue as indicated in block 380.

Referring to FIG. 4, blocking map 400 may be used to illustrate how algorithm 200 and 300 create and maintain blocking map 400. A new disk request 210 in FIG. 2 may be disk request 490 in FIG. 4 which may be operating on data in cache line 470 of cache 460, in this example. Since the last request field, in this example, may point to disk request 440, the last request field is not equal to null. Therefore, disk request 490 may be added to disk request 440's blocking list, as suggested in block 230. Additionally, disk request 490 may have its blocked count incremented from 0 to 1, as suggested in block 240. Disk Request 490 will be set as the last request in cache line 470. Disk requests 410 and 420 are not blocked and may be executed in due order.

If disk request 420 completes execution, then the relevant cache line's last request data may be compared to determine if it is equal to the completed disk request 420, as indicated in 320. Since disk request 420 is not the last request for either cache line (CL) 470 or 480 in this example, the blocked count for disk requests 430 may be decremented since it may be on the disk request 420's blocking list, as suggested in by diamond 320. Disk request 430 blocked count may be equal to 1, as suggested by block 340. Disk request 410 is still unblocked. When disk request 410 completes execution, disk requests 430 becomes unblocked since its block count goes to zero. Disk requests 440, 490 and 450 blocked count are still set to 1 each reflecting disk requests 430 blocking position.

Blocking graph 400 may be stored in system memory or in disk cache. In one embodiment, blocking graph 400 is stored in volatile memory such as a dynamic random access memory. In other embodiments, blocking graph 400 may be stored in a polymer which may include a ferromagnetic memory.

While the present invention has been described with respect to a limited number of embodiments, those skilled in the art will appreciate numerous modifications and variations they are from. It is intended that the appended claims cover all such modifications and variations as fall within the scope of the claims.

What is claimed is:

1. A method comprising:
receiving two requests to access a cache for a disk drive;
determining if the two requests are addressed to the same logical block address of said disk drive;
if said requests are addressed to the same logical block address, blocking one of the requests; and
if said requests are not to the same logical block address, allowing the request to proceed without blocking.

2. The method of claim 1 further comprising executing a non-blocked disk request.

3. The method of claim 2 further comprising setting a last request field to null when a last request for a cache line is executed.

4. The method of claim 2 further comprising decrementing a blocked count for a disk request that was blocked by an executed disk request.

5. The method of claim 4 further comprising unblocking said request if said blocked count for said request is equal to zero.

6. A computer readable medium storing instructions that, if executed, enable a processor-based system to:
receive two requests to access a cache for a disk drive;
determine if the two requests are addressed to the same logical block address of said disk drive;
if said requests are addressed to the same logical block address, block one of the requests; and
if said requests are not to the same logical block address, allow the request to proceed without blocking.

7. The medium of claim 6 further storing instructions that, if executed, enable a processor-based system to execute a non-blocked request.

8. The medium of claim 7 further storing instructions that, if executed, enable a processor-based system to set a last request field to null when a last request for a cache line is executed.

9. The medium of claim 7 further storing instructions that, if executed, enable a processor-based system to decrement a blocked count for a disk request that was blocked by an executed disk request.

10. The medium of claim 9 further storing instructions that, if executed, enable a processor-based system to unblock said disk request if said blocked count for said disk request is equal to zero.

11. A memory device storing instructions that, if executed, enable a system to:
receive two requests to access a cache for a disk drive;
determine if the two requests are addressed to the same logical block address of said disk drive;
if said requests are addressed to the same logical block address, block one of the requests; and
if said requests are not to the same logical block address, allow the request to proceed without blocking.

12. The memory device of claim 11 further comprising storing instructions that if executed, enable a system to execute a non-blocked request.

13. The memory device of claim 12 further comprising storing instructions that, if executed, enable a processor-based system to set a last request field to null when a last request for a cache line is executed.

14. The memory device of claim 12 further comprising storing instructions that, if executed, enable a system to decrement a blocked count for a disk request that was blocked by an executed disk request.

15. The memory device of claim 14 further comprising instructions that, if executed, enable a system to unblock said request if said blocked count for said request is equal to zero.

16. A system comprising:
a cache;
a disk drive coupled to said cache; and
at least one memory device coupled to said cache storing instructions that if executed, enable a system to receive two requests to access a cache for a disk drive, determine if the two requests are addressed to the same logical block address of said disk drive, if said requests are addressed to the same logical block address, block one of the requests, and if said requests are not to the same logical block address, allow the request to proceed without blocking.

17. The system of claim 16 wherein said at least one memory device comprises dynamic random access memory.

18. The system of claim 16 wherein said cache comprises non-volatile memory.

19. The system of claim 16 wherein said cache further comprises a polymer memory.

20. The system of claim 16 wherein said cache further comprises a ferroelectric memory.

21. A method comprising blocking a pending disk request responsive to a blocked count data field.

22. The method of claim 1 further comprising blocking a pending disk request responsive to a blocking list data field.

23. The method of claim 1 further comprising blocking a pending disk request responsive to a last request data field.
